(19) United States
(12) Patent Application Publication
(10) Pub. No.: US 2007/0222879 A1
(43) Pub. Date: Sep. 27, 2007

(54) Sub-ranging pixel sample and hold

(75) Inventors: Robert C. Glenn, Bend, OR (US); Edward S. Milligan, Redding, CA (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/388,490

(22) Filed: Mar. 24, 2006

(51) Int. Cl. H04N 3/14; H04N 5/335

(52) U.S. Cl. 348/297

(57) ABSTRACT

Apparatus, systems and methods for image sensor leakage and dark current compensation are disclosed. In one implementation, a method is disclosed including accumulating charge on a first hold capacitance of an imaging pixel, and accumulating charge on a second hold capacitance of the pixel in response to the first hold capacitance reaching a predetermined voltage level. Other implementations are disclosed.

### BACKGROUND

A pixel in a typical complementary metal oxide semiconductor (CMOS) imaging device stores photo-induced charge on a single hold capacitor. The amount of charge that a CMOS imaging pixel can store, also known as the pixel's “well capacity,” is proportional to the capacitance or “size” of the hold capacitor. There are, however, competing effects that make choosing the size of the hold capacitor a difficult design decision for developers of CMOS imaging devices. On the one hand, larger pixel well capacitance increases a pixel's signal-to-noise (S/N) ratio because larger charge capacity increases the dynamic range of the pixel thus reducing the magnitude of shot noise relative to the stored voltage. On the other hand, a smaller capacitance is preferable because smaller well capacitance enhances low-light response while reducing read error (e.g., kTC noise etc.).

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 illustrates an example imaging system in accordance with some implementations of the invention;

FIG. 2 is a schematic diagram illustrating an imaging pixel in accordance with some implementations of the invention;

FIG. 3 is a schematic diagram illustrating another imaging pixel in accordance with some implementations of the invention;

FIG. 4 is a schematic diagram illustrating yet another imaging pixel in accordance with some implementations of the invention;

FIG. 5 is a flow chart illustrating an example process 300 in accordance with some implementations of the invention;

FIG. 6 is a schematic diagram illustrating another imaging pixel in accordance with some implementations of the invention;

FIG. 7 is a flow diagram illustrating another example process 500 in accordance with some implementations of the invention; and

FIG. 8 is a schematic diagram illustrating another imaging pixel in accordance with some implementations of the invention.

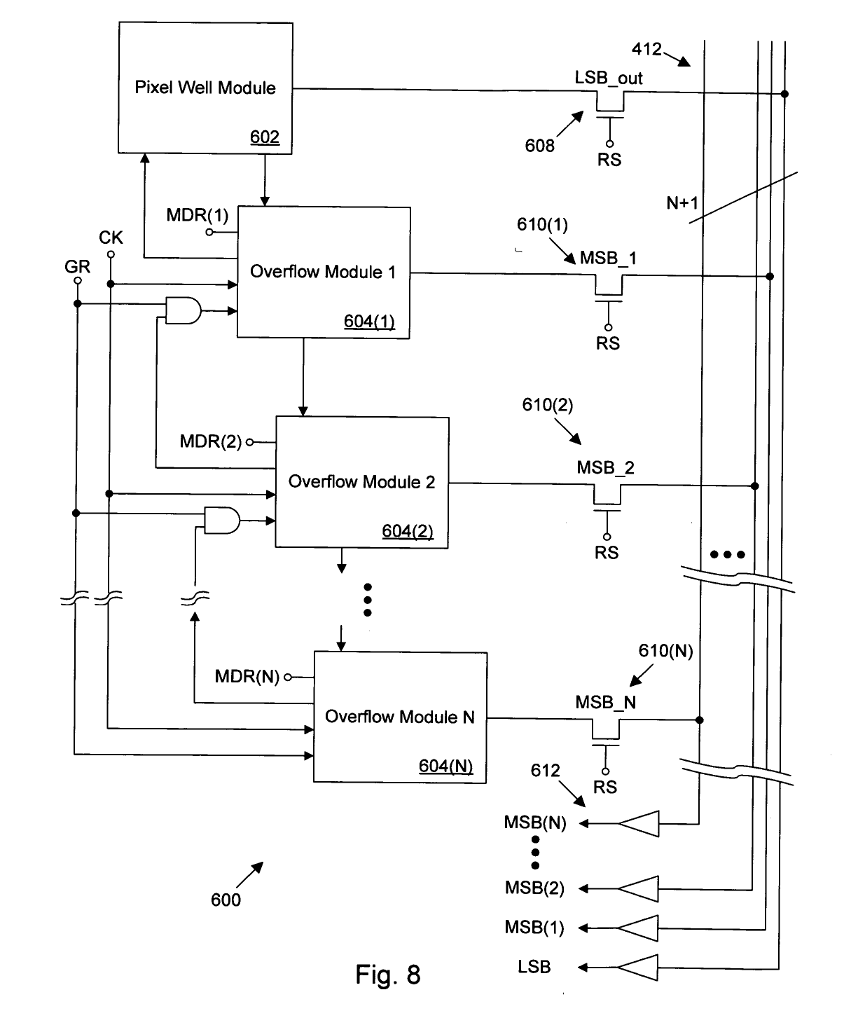

### DETAILED DESCRIPTION

The following detailed description refers to the accompanying drawings. The same reference numbers may be used in different drawings to identify the same or similar elements. In the following description specific details may be set forth such as particular structures, architectures, interfaces, techniques, etc. in order to provide a thorough understanding of the various aspects of the claimed invention. However, such details are provided for purposes of explanation and should not be viewed as limiting with respect to the claimed invention. With benefit of the present disclosure it will be apparent to those skilled in the art that the various aspects of the invention claimed may be practiced in other examples that depart from these specific details. Moreover, in certain instances, descriptions of well known devices, circuits, and methods are omitted so as not to obscure the description of the present invention with unnecessary detail.

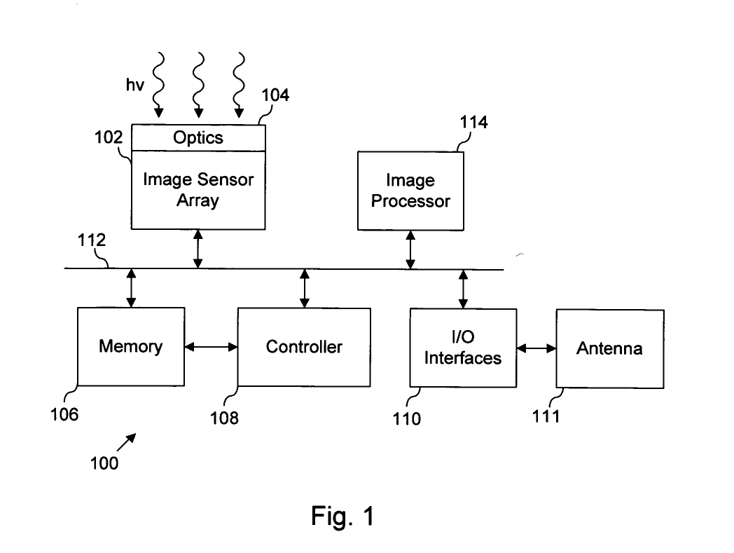

FIG. 1 illustrates an example system 100 in accordance with some implementations of the invention. System 100 includes an image sensor 102, light gathering optics 104, memory 106, a controller 108, one or more input/output (I/O) interfaces 110 (e.g., universal synchronous bus (USB) interfaces, parallel ports, serial ports, telephone ports, wired and wireless network interfaces and/or other I/O interfaces) an image processor 114, and a shared bus or other communications pathway 112 coupling devices 102 and 106-110 together for the exchange of image data and/or control data. System 100 may also include an antenna 111 (e.g., dipole antenna, narrowband Meander Line Antenna (MLA), wideband MLA, inverted “F” antenna, planar inverted “F” antenna, Goubau antenna, Patch antenna, etc.) coupled to a wireless interface of I/O interfaces 110.

System 100 may assume a variety of physical manifestations suitable for implementation of sub-ranging pixel sample and hold in accordance with some implementations of the invention. For example, system 100 may be implemented within a digital imaging device (e.g., digital camera, camera cell-phone, etc.). Moreover, various components of system 100 may be implemented in an integrated configuration rather than as discrete components. For example, array 102, and/or memory 106, and/or controller 108 and/or interfaces 110 may be implemented within one or more semiconductor device(s) and/or integrated circuit (IC) chip(s) (e.g., within a chipset, system-on-a-chip (SOC), etc.). In addition, various components that might be associated with system 100 but that are not particularly relevant to the claimed invention (e.g., audio components, display-related devices, etc.) have been excluded from FIG. 1 so as to not obscure the invention.

Light gathering optics 104 may be any collection of light gathering optical elements capable and/or suitable for collecting light and providing that light to sensor 102. Although those skilled in the art will recognize that optics 104 may comprise various optical components and/or arrangement of optical components, the specific nature of optics 104 is not limiting with respect to the invention and hence will not be described in further detail.

Memory 106 may be any device and/or mechanism capable of storing and/or holding imaging data including color pixel data and/or component values, to name a few examples. For example, although the invention is not limited in this regard, memory 106 may be either volatile memory such as static random access memory (SRAM), dynamic random access memory (DRAM), or non-volatile memory such as flash memory.

Controller 108 may be, in various implementations, any logic and/or collection of logic devices capable of manipulating imaging data in order to implement sub-ranging pixel sample and hold processes in accordance with some implementations of the invention. For example, controller 108 may be an image controller and/or signal processor. However, the invention is not limited in this regard and controller 108 may be implemented in a general purpose processor, microprocessor, and/or microcontroller to name a few other examples. Further, controller 108 may comprise a single device (e.g., a microprocessor or an application specific IC (ASIC)) or may comprise multiple devices. In one implementation, controller 108 may be capable of performing any of a number of tasks that support processes for sub-ranging pixel sample and hold. These tasks may include, for example, although the invention is not limited in this regard, downloading microcode, initializing and/or configuring registers, and/or interrupt servicing. Controller 108 may be coupled to antenna 111 so that antenna 111 may convey control data, such as microcode, to controller 108 where that control data is provided by a device external to system 100. Controller 108 may also provide control signals to array 102 as will be explained in greater detail below.

Image processor 114 may be any collection of control and/or processing logic suitable for processing image data provided by array 102 and/or controller 108 such that the image data is placed in a suitable format for use by other devices that may be coupled to system 100 but are not shown in FIG. 1 (such as a display or a printer). In one implementation, processor 114 may comprise a display processor and/or controller at least capable of processing the image data output of array 102 to place it in a form suitable for displaying on a monitor or other type of display (not shown). For example, processor 114 may be capable of interpolating the image data supplied by array 102.

In another implementation, processor 114 may comprise a printer processor and/or controller at least capable of processing the output of array 102 to place it in a form suitable for printing on a printer or similar device (not shown). For example, processor 114 may be capable of color converting the array's image data. In a further implementation, processor 114 may comprise a multimedia processor or controller at least capable of multimedia processing the output of array 102. For example, processor 114 may be capable of blending array 102's image data with other image data.

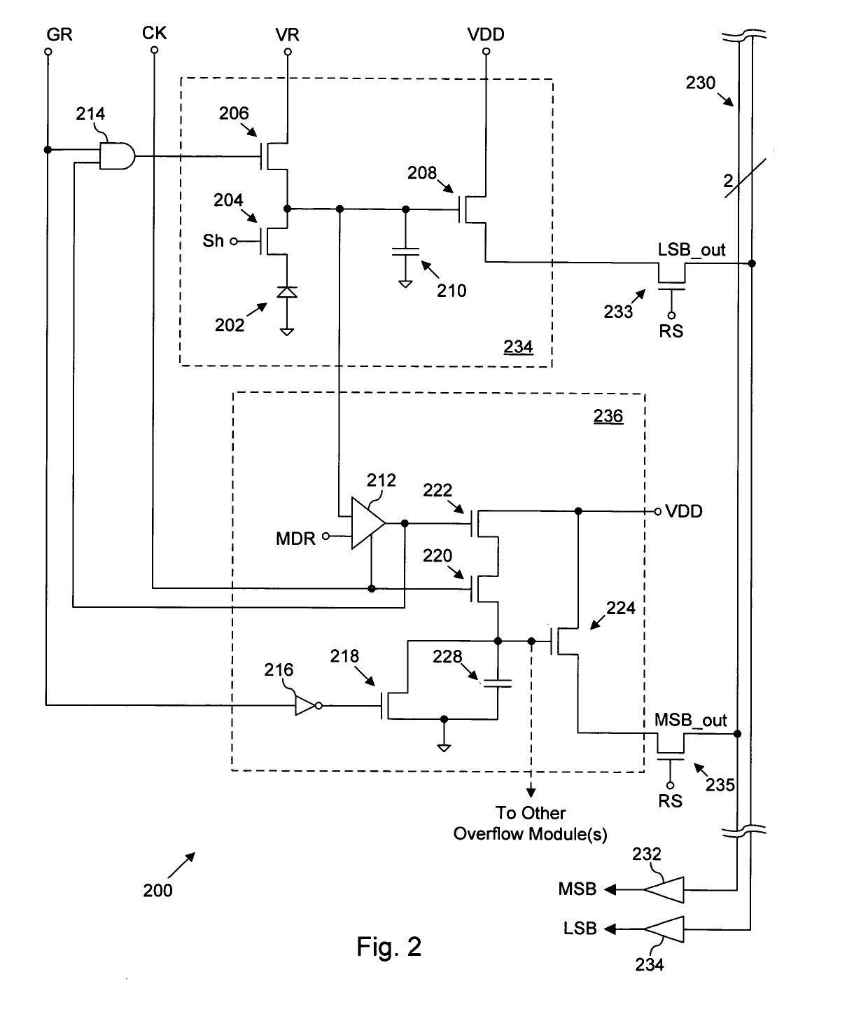

FIG. 2 is a schematic diagram illustrating a pixel 200 of an image sensor array, such as array 102 of FIG. 1, in accordance with some implementations of the invention. Pixel 200 includes a photodiode 202, a transfer gate device or transistor 204, a sample/hold reset transistor 206, a buffer transistor 208, a first hold capacitance 210, a comparator 212, an AND logic gate 214, an inverter 216, a global reset transistor 218, a pulse clock transistor 220, a pulse charge transistor 222, an accumulate transistor 224, a second hold capacitance or overflow hold capacitance 228, a 2-bit column address bus 230, analog-to-digital converters (ADCs) 232 and 234, and row select devices 233 and 235. Those skilled in the art will recognize that some conventional components of an imaging sensor pixel (e.g., row address line, etc.) that are not particularly germane to the invention have been excluded from FIG. 2 in the interests of clarity. To further aid discussion of FIG. 2 and subsequent figures, components 202-210 of pixel 200 may be described as collectively comprising a pixel well module 234 while components 212-228 of pixel 200 may be described as collectively comprising an overflow module 236.

In accordance with some implementations of the invention, comparator 212 may compare the voltage on capacitance 210 to a reference voltage where the reference voltage may correspond to a predetermined charge or voltage level of capacitance 210 (i.e., that voltage corresponding to a maximum acceptable dynamic range (MDR) of capacitance 210). Comparator 212 may, under modulation by clock source (CK) trigger transistor 222, charge second hold capacitor 228 with a quantity of charge (i.e., a unit quantity of charge set by the duration of CK) when the voltage or charge on capacitance 210 reaches and/or exceeds the reference voltage MDR. In accordance with some implementations of the invention, the value of the reference voltage MDR may be chosen to substantially match the voltage or charge to be found on capacitance 210 when it is close to and/or at saturation.

Capacitance 210 and other capacitances described herein may comprise any device or structure capable of storing or accumulating charge. Thus, for example, capacitance 210 may comprise a thin-film capacitor formed in an imaging device (e.g., an imaging IC), although the invention is not limited in this regard. Moreover, those skilled in the art will recognize that while device 210 and similar devices are referred to herein as “capacitors” the invention is not limited in this regard and device 210 and similar devices may be any device or structure capable of storing or accumulating charge. Thus, for example, device 210 may comprise a potential well storage device that captures converted charge resulting from semiconductor photonic interactions.

In accordance with some implementations of the invention hold capacitance 210 may have a small capacitance value (e.g., 0.25 femto-farads (fF)) to reduce read error and/or improve the low-light imaging characteristics of pixel 200. In accordance with some implementations of the invention, when comparator 212 triggers transistor 222 to charge capacitor 228 it may also source charge away from hold capacitance 210 by resetting and/or discharging capacitance 210 via reset transistor 206. In this manner, in accordance with the invention, capacitor 228 may, by storing incremental units of charge sourced by comparator 212, act as a “counter” of the number of times that capacitance 210 has reached its maximum acceptable dynamic range. At the same time, because charge is sourced away from capacitance 210, the pixel well capacity of pixel 200 is, in effect, increased.

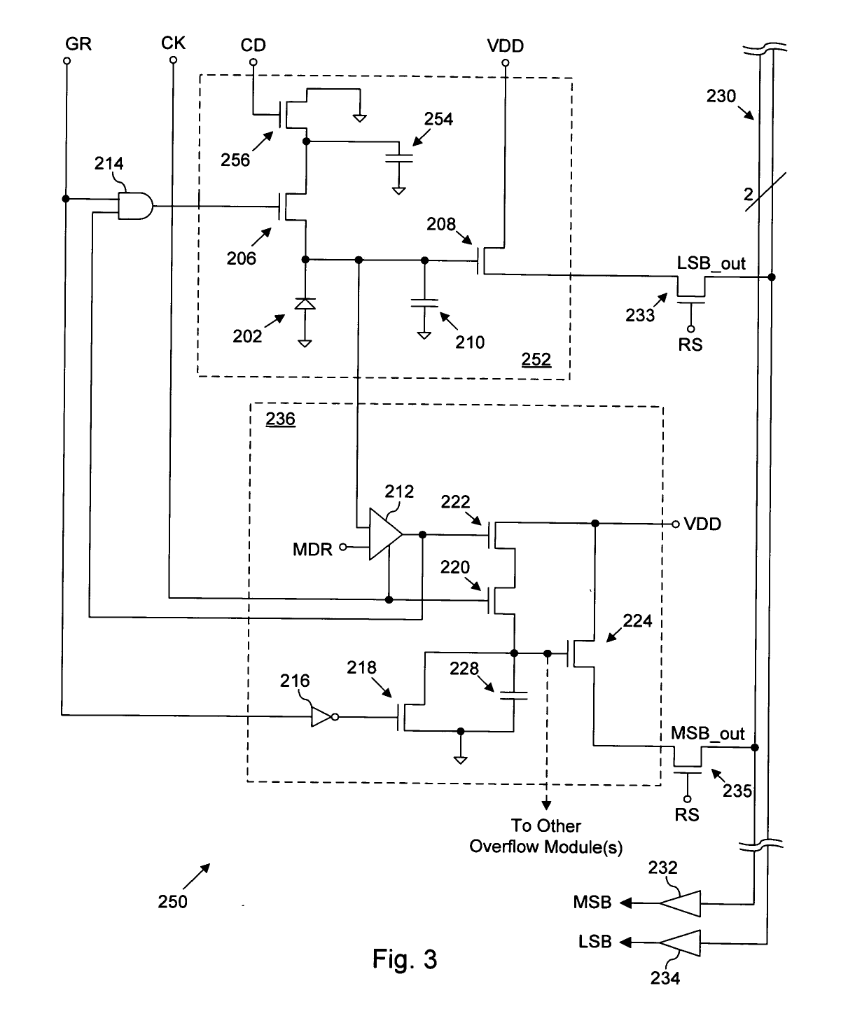

FIG. 3 is a schematic diagram illustrating a pixel 250 of an image sensor array, such as array 102 of FIG. 1, in accordance with other implementations of the invention. While pixel 250 includes many devices previously described with regard to pixel 200 of FIG. 2, pixel 250 implements a pixel well module 252 distinct from well module 234 of pixel 200. In particular, well module 252 incorporates a shunt or dump capacitor 254 and a charge dump device 256.

As will be described in further detail below, when comparator 212 triggers transistor 222 to charge capacitor 228 it may also source charge away from capacitance 210 by shunting or dumping a quantity of charge from capacitance 210 to capacitance 254 via reset transistor 206. In this manner, in accordance with some implementations of the invention, capacitors 228 and 254 may, by removing quanta of charge from hold capacitor 210, act as a “counter” of the number of times that capacitance 210 has reached its maximum acceptable dynamic range while also partially discharging or reducing the charge stored on capacitance 210 thereby effectively allowing for a larger pixel well capacity for pixel 250 without fully resetting or discharging capacitor 210. Charge dump device 256 allows charge on capacitor 254 to be sourced to ground in response to a charge dump (CD) control signal.

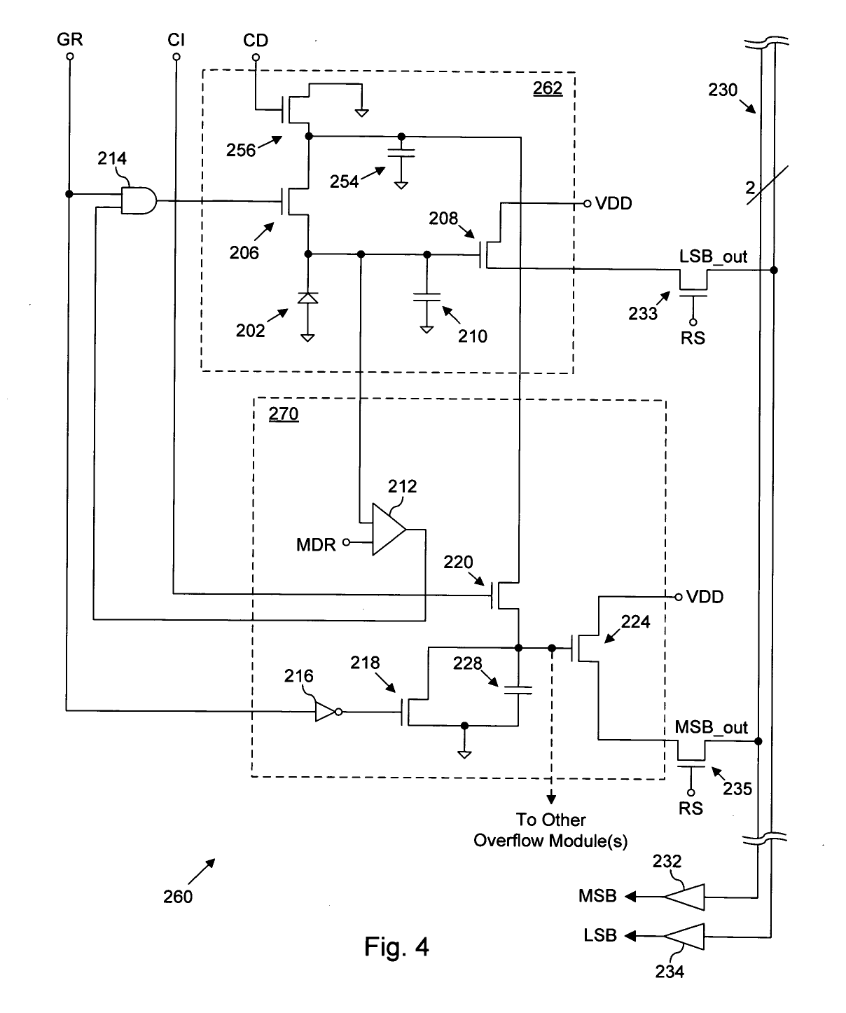

FIG. 4 is a schematic diagram illustrating a pixel 260 of an image sensor array, such as array 102 of FIG. 1, in accordance with yet other implementations of the invention. While pixel 260 includes many devices previously described with regard to pixels 200 and 250 of FIGS. 2-3, pixel 260 implements both a pixel well module 262 distinct from well module 234 of pixel 200, and an overflow module 270 distinct from module 236 of pixel 200. In particular, pixel 260 couples shunt or dump capacitor 254 to overflow hold capacitor 228 via device 220 in response to a charge increment control signal (CI). As in pixel 250, shunt capacitor 254 may be reset in response to a charge dump signal (CD) supplied to device 256.

As will be described in further detail below, when comparator 212 is triggered it may act to source charge away from capacitance 210 by shunting or dumping a quantity of charge from capacitance 210 to capacitance 254 via reset transistor 206. In addition, charge on capacitance 254 may be sourced to overflow hold capacitor 228 in response to a charge increment (CI) control signal. In this manner, in accordance with the invention, capacitors 254, and 228 may, by sourcing charge away from hold capacitor 210, act as a “counter” of the number of times that capacitance 210 has reached its maximum acceptable dynamic range while also partially discharging or reducing the charge stored on capacitance 210 thereby effectively allowing for a larger pixel well capacity for pixel 260 without fully resetting or discharging capacitor 210. In accordance to some implementations of the invention capacitance 264 may have a substantially smaller charge storage capacity than capacitance 228.

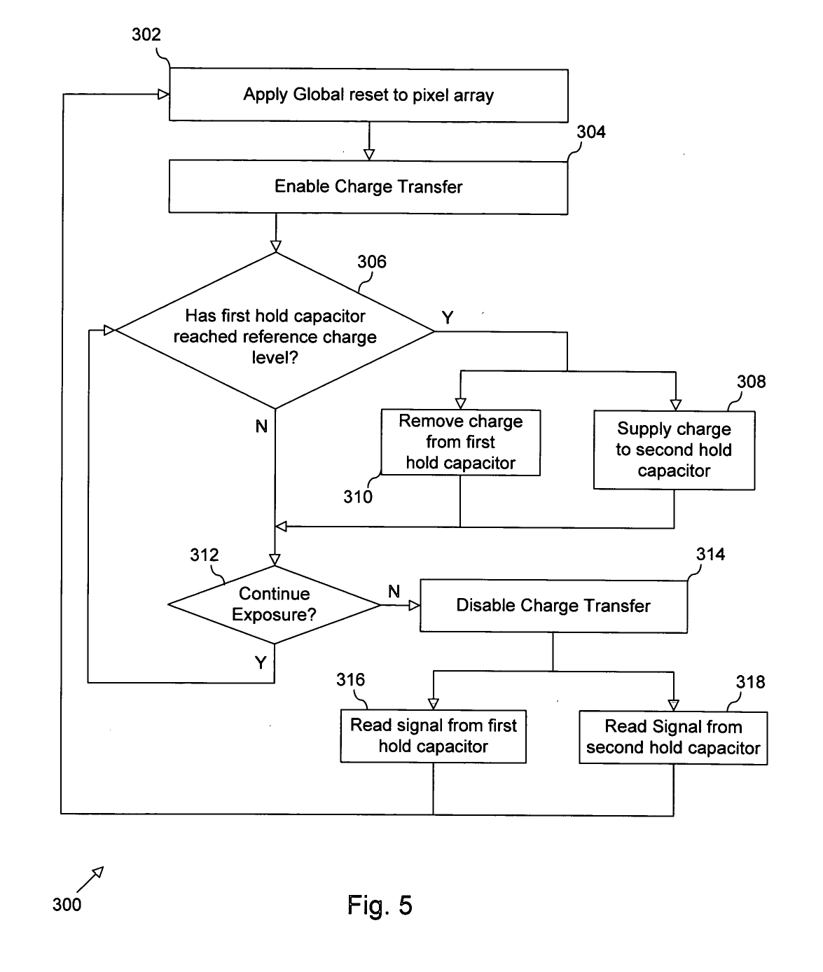

FIG. 5 is a flow diagram illustrating a process 300 for implementing sub-ranging pixel sample and hold in accordance with some implementations of the invention. While, for ease of explanation, process 300, and associated processes, may be described with regard to system 100 of FIG. 1 and/or pixels 200, 250 or 260 of FIGS. 2-4, the invention is not limited in this regard and other processes or schemes supported and/or performed by appropriate devices and/or combinations of devices in accordance with the invention are possible.

Process 300 may begin with the application of a global reset to a pixel array [act 402]. In some implementations, referring to pixel 200, controller 108 may initiate a global reset to pixel 200 by supplying a global reset signal (GR) to gate 214. When supplied with the reset signal GR reset transistor 206 may apply a reset potential or voltage (VR) to capacitance 210 thereby placing and/or discharging and/or resetting first hold capacitance 210 to a voltage characteristic of an unexposed pixel. In addition, the global reset signal GR may be inverted by inverter 216 and the inverted GR signal supplied to global reset transistor 218 thereby discharging and/or resetting the second hold capacitor 228 to a voltage characteristic of an unexposed pixel.

In other implementations, referring to pixel 250, controller 108 may initiate a global reset by supplying a global reset signal (GR) to gate 214. When supplied with the reset signal GR, reset transistor 206 may place and/or discharge and/or reset both first hold capacitance 210 and dump capacitance 254 to a voltage characteristic of an unexposed pixel. In addition, as above with pixel 200, the global reset signal GR may be inverted by inverter 216 and the inverted GR signal supplied to global reset transistor 218 thereby discharging and/or resetting the second hold capacitor 228 to a voltage characteristic of an unexposed pixel.

Process 300 may continue with the enabling of charge transfer [act 304]. In accordance with some implementations of the invention, act 304 may be undertaken by having controller 108 supply a charge transfer signal to transistor 204 of pixel 200 thereby exposing first hold capacitance 210 to any photo-induced charge supplied by photodiode 202. With respect to implementations utilizing pixels 250 or 260, act 304 need not be undertaken.

Process 300 may continue with a determination of whether the first hold capacitor has reached a reference charge level [act 306]. One way to do this is for controller 108 to provide comparator 212 of either pixels 200, 250, or 260 with a reference voltage (e.g., MDR). Comparator 212 may then be triggered when the voltage (charge) on first hold capacitance 210 reaches or exceeds this predetermined voltage level.

If the determination of act 306 is positive, in other words if the charge on capacitor has been determined to reach or exceed a reference charge level such that comparator 212 is triggered, then process 300 may continue with the supply of charge to the second hold capacitor [act 308]. In some implementations, referring to pixel 200, when the charge on the first hold capacitance 210 has been determined to reach or exceed a reference charge level then comparator 212 may, under modulation of transistor 220 by clock source CK, pulse a small quantity of charge onto second hold capacitor 228 via transistors 220 and 222. Clock source CK may, while modulating the output of comparator 212, also act to reset the output of comparator 212 during the implementation of acts 308-310. Thus, in accordance with some implementations of the invention, act 308 may result in the storing of a unit or quanta of charge on second hold capacitor 228 to indicate that first hold capacitance 210 has achieved saturation at least once.

In other implementations, referring to pixel 250, when charge on the first hold capacitance 210 has been determined to reach or exceed a reference charge level then act 308 may be undertaken by having comparator 212, under modulation of transistor 220 by clock source CK, pulse a small quantity of charge onto second hold capacitor 228 via transistors 220 and 222. Clock source CK may, while modulating the output of comparator 212, also act to reset the output of comparator 212 during the implementation of acts 308-310. Further, comparator 212 may, via gate 214, cause transistor 206 to source a quanta or increment of charge from capacitance 210 to dump or shunt capacitance 254. In this way, act 308 undertaken with pixel 250 permits the charge or voltage on capacitance 210 to at least be reduced if not reset by sourcing charge to capacitance 254. Further, once capacitance 254 has been used to shunt charge away from capacitance 210, capacitance 254 may be reset or shorted to ground in response to a CD signal supplied to transistor 256.

In yet other implementations, referring to pixel 260, when the charge on the first hold capacitance 210 has been determined to reach or exceed a reference charge level then act 308 may be undertaken by having comparator 212, via gate 214, cause transistor 206 to source a quanta or increment of charge from capacitance 210 to dump or shunt capacitance 254. In addition, in response to a charge increment (CI) signal supplied to device 220, charge shunted to capacitance 254 may be transferred to overflow hold capacitance 228. In this way, act 308 undertaken with pixel 260 permits the charge or voltage on capacitance 210 to at least be reduced if not reset by sourcing charge to capacitance 254.

Process 300 may also include the removal of charge from the first hold capacitance [act 310]. With respect to pixel 200, comparator 212 may, in conjunction with act 308, also undertake act 310 by pulsing gate 214 with a local reset signal thereby causing reset transistor 206 to momentarily apply a reset potential or voltage (VR) to first hold capacitance 210. Thus, in accordance with some implementations of the invention, the consummation of acts 306-310 may result in the resetting of first hold capacitance 210 so that the first hold capacitance 210 may continue to accumulate photo-induced charge if need be.

With respect to the implementations of pixel 250 or pixel 260, the quantity of charge pulsed onto second hold capacitor 228 during act 308 may depend on the capacitance value of capacitance 254. Thus, in the context of pixels 250 and 260, act 310 may result in some but not all charge being removed from capacitance 210.

Process 300 may continue with a determination of whether to continue exposure of the array [act 312]. In one implementation of the invention, controller 108 may continue exposing pixel 200 depending upon a pre-determined exposure duration. If exposure of the array is to continue (i.e., the determination of act 312 is positive) then the determination of act 306 may be undertaken again. Thus, as FIG. 5 shows, as long as the determination of act 312 is positive then consecutive iterations of acts 306-312 may occur. In implementations employing pixel 200, each iteration of acts 308 and 310 may result in the storing of an additional unit of charge on second hold capacitor 228 and the resetting of first hold capacitance 210. In implementations employing pixels 250 and 260, each iteration of acts 308 and 310 may result in the storing of an additional unit of charge on second hold capacitor 228 and the removal of some charge from first hold capacitance 210.

If the determination of act 312 is negative, in other words if exposure of the array is not to continue, then process 300 may continue with the disabling of charge transfer [act 314]. In implementations employing pixel 200 one way to do this is if, in undertaking act 312, controller 108 determines that a pre-determined exposure duration has been met then controller may release the charge transfer signal supplied to transistor 204 thereby isolating first hold capacitance 210 from photodiode 202 so that no significant additional photo-induced charge is accumulated on first hold capacitance 210. In implementations employing pixels 250 and 260, act 314 may be undertaken by a global shutter mechanism (not shown) that acts to prevent the exposure of diode 202 to additional light.

Process 300 may continue with the reading of the signal from the first hold capacitor [act 316] and from the second hold capacitor [act 318]. In accordance with either the implementation of pixels 200, 250 or 260, acts 316 and 318 may be undertaken by having controller 108 supply a row select signal (RS) to row select transistors 236 and 238 thereby supplying respective voltage levels from first hold capacitance 210 and second hold capacitor 228 to column address bus 230.

As those skilled in the art may recognize, the analog voltage level of first hold capacitance 210 sampled in act 316 may be thought of as representing the least significant bits (LSBs) of the total voltage (charge) corresponding to the illumination experienced by pixels 200, 250 or 260 during acts 304-314. Similarly, the analog voltage level of second hold capacitor 228 sampled in act 318 may be thought of as representing the most significant bits (MSBs) of the total voltage (charge) corresponding to the illumination experienced by pixels 200, 250 or 260 during acts 304-314. When the analog voltage signals from capacitors 210 and 228 are collected or sampled in acts 316 and 318 those signals may be converted to from analog to digital signals by ADCs 234 and 232 to generate the respective digital output signals MSB and LSB of pixel 200.

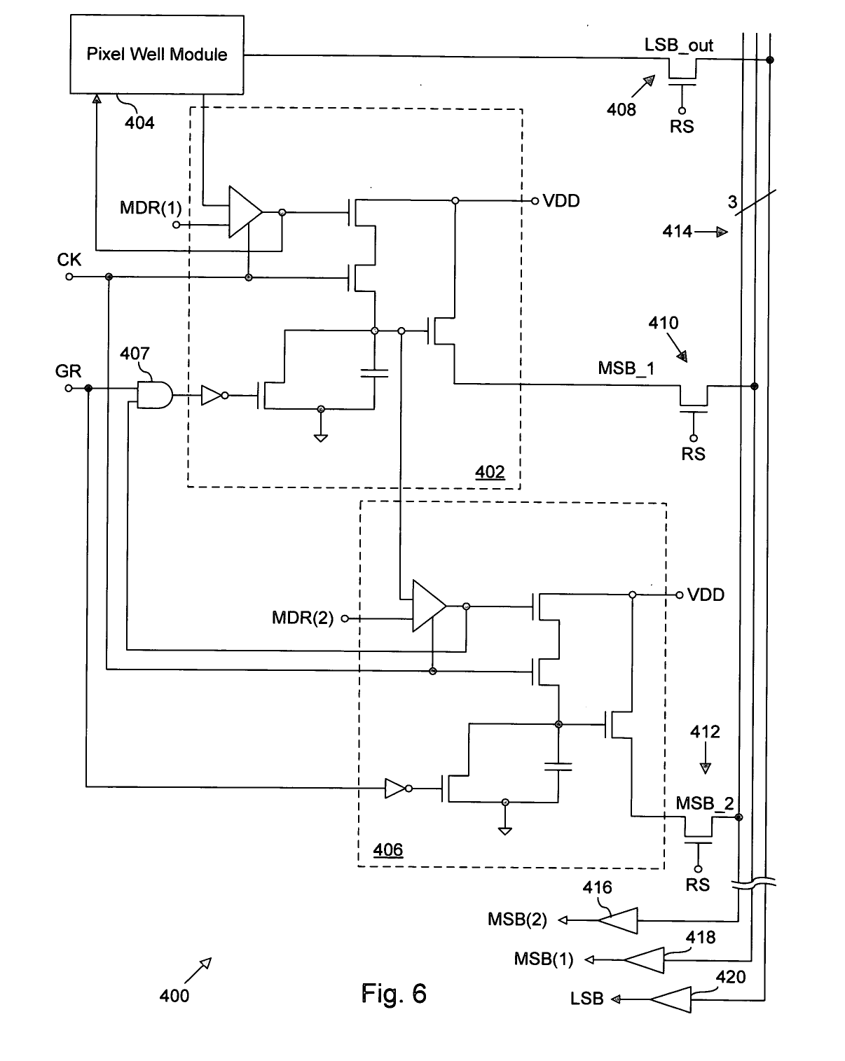

FIG. 6 illustrates another example pixel 400 in accordance with another implementation of the invention. Pixel 400 includes a first overflow module 402 coupled to a pixel well module 404, and a second overflow module 406 coupled to the first overflow module 402. In the implementation of pixel 400, well module 404 of pixel 400 may be similar to well module 234 of FIG. 2, module 252 of FIG. 3, or module 262 of FIG. 4 and thus components internal to well module 404 are not shown in detail in FIG. 4. Likewise, overflow modules 402 and 406 of pixel 400 may include components similar to those of overflow module 236 of pixels 200 or 250. If well module 404 of pixel 400 is similar to module 262 of pixel 260 then overflow modules 402 and 406 of pixel 400 may likewise be similar to overflow module 270 of pixel 260. Pixel 400 also includes AND gate 407, row select transistors 408, 410 and 412 that, in response to a row select signal (RS), may supply respective analog output signals LSB_out, MSB 1, and MSB_2 to a 3-bit column address bus 414. Address bus 414 may, in turn, terminate in ADCs 416-420.

One way that the implementation of pixel 400 of FIG. 4 differs from the implementation of either pixels 200, 250 or 260 of FIGS. 2-4 is that overflow module 402 of pixel 400 may act as an overflow counter of well module 404 while overflow module 406 may act as an overflow counter of overflow module 402. In other words, overflow module 402 may count the number of times that well module 404 has overflowed while, in turn, overflow module 406 may count the number of times that overflow module 402 has overflowed. Thus, in accordance with some implementations of the invention, pixel 400 may incorporate a cascaded set of overflow modules 402 and 406. The invention is, however, not limited to a specific number of pixel overflow modules and other pixel architectures incorporating one, two, or more than two overflow modules may be implemented in accordance with the invention.

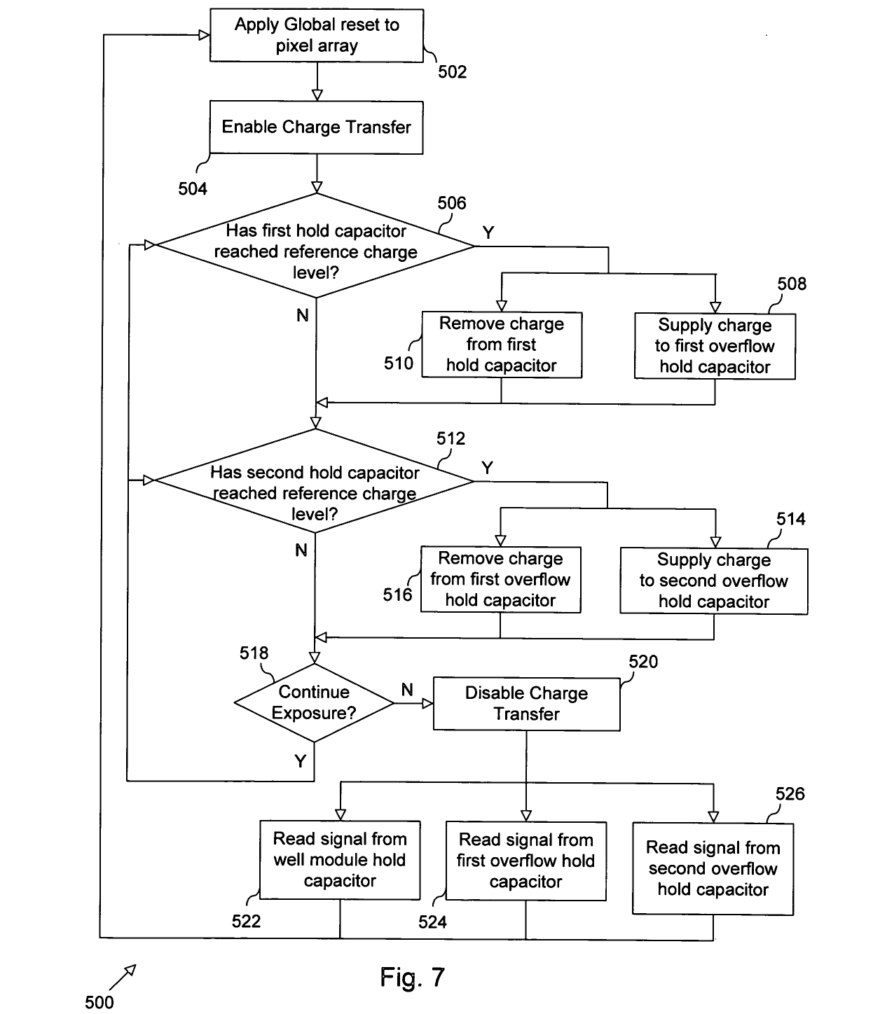

FIG. 7 is a flow diagram illustrating a process 500 for implementing sub-ranging pixel sample and hold in accordance with an implementation of the claimed invention wherein two overflow modules are utilized. While, for ease of explanation, process 500, and associated processes, may be described with regard to system 100 of FIG. 1 and/or pixel 400 of FIG. 4, the claimed invention is not limited in this regard and other processes or schemes supported and/or performed by appropriate devices and/or combinations of devices in accordance with the claimed invention are possible.

Process 500 may begin with the application of a global reset to a pixel array [act 502]. In one implementation, controller 108 may initiate a global reset to pixel 400 of array 102 by supplying a global reset signal (GR). When supplied with the reset signal GR the capacitors of both overflow modules 402 and 406 may be discharged and/or set and/or reset to a voltage characteristic of a substantially uncharged capacitor.

Process 500 may continue with the enabling of charge transfer [act 504]. Act 504 is similar to act 304 described above and thus will not be described in more detail. Process 500 may continue with a determination of whether the well module's hold capacitor has reached a reference charge level [act 506]. One way to do this is for controller 108 to provide the comparator of overflow module 402 with a reference voltage (MDR(1)). Module 402's comparator may then be triggered when the voltage (charge) on the well 404's hold capacitor reaches or exceeds this reference voltage level.

If the determination of act 506 is positive, in other words if the charge on the hold capacitor of well module 404 has been determined to reach or exceed the reference charge level, then process 500 may continue with the supply of charge to the hold capacitor of the first overflow module 402 [act 508] and removal of charge from the well module's hold capacitor [act 510]. In some implementations of the invention, when the charge on the well module's capacitor has been determined to reach or exceed the reference charge level MDR(1) then overflow module 402's comparator may pulse a small quantity of charge onto module 402's overflow hold capacitor. Thus, in accordance with some implementations of the invention, the consummation of acts 506-510 may result in the storing of a unit of charge on the overflow hold capacitor of overflow module 402 to indicate that well 404's hold capacitor has reached saturation at least once.

While undertaking act 508, module 402 may, if pixel well 404 is similar to well 234 of pixel 200, also undertake act 510 by supplying a local reset signal to well module 404 so that to well module 404 may momentarily apply a reset potential or voltage to its hold capacitor. Thus, in accordance with some implementations of the invention, the consummation of acts 506-510 may also result in the resetting of the well module's hold capacitor so that it may continue to accumulate photo-induced charge if need be. In the context of pixel well 404 implementing a pixel well similar to well 252 of pixel 250 or well 262 of pixel 260, act 508 may result in the reduction of charge stored on well 404's hold capacitor so that it may continue to accumulate photo-induced charge if need be.

Process 500 may continue with a determination of whether the overflow hold capacitor of overflow module 402 has reached a reference charge level [act 512]. One way to do this is for controller 108 to provide the comparator of overflow module 406 with a reference voltage (MDR(2)). Module 406's comparator may then be triggered when the voltage (charge) on the first overflow hold capacitor of module 402 has reached or exceeded this reference voltage level. Act 512 is undertaken in a similar manner in other implementations of the invention where, for example, module 404 is similar to well 252 of pixel 250 or in implementations where module 404 is similar to well 262 and modules 402 and 406 are similar to module 270 of pixel 260.

If the determination of act 512 is positive, in other words if the charge on the first overflow hold capacitor of overflow module 402 has been determined to reach or exceed the reference charge level, then process 500 may continue with the supply of charge to the overflow hold capacitor of the second overflow module [act 514] and the removal of charge from the first overflow hold capacitor [act 516]. In some implementations of the invention, when the charge on the first overflow hold capacitor of module 402 has been determined to reach or exceed the reference charge level MDR(2) then module 406's comparator may pulse a small quantity of charge from that module's current source to its overflow hold capacitor.

While undertaking act 514, comparator 408 may also undertake act 516 by supplying a local reset signal to well module 404 so that to overflow module 402 may momentarily apply a reset potential or voltage to first overflow hold capacitor 403. Thus, in accordance with the invention, the consummation of acts 512-514 may also result in the resetting of the overflow module 402's overflow hold capacitor 403 may continue to accumulate overflow events if need be. Thus, in accordance with some implementations of the invention, the consummation of acts 512-516 may result in the resetting of overflow module 402's overflow hold capacitor and the storing of a unit of charge on the overflow hold capacitor of module 406 to indicate that module 402's overflow hold capacitor has reached saturation at least once.

In other implementations of the invention, in the context of pixel well 404 implementing a pixel well similar to well 252 of pixel 250 and overflow modules 402/406 similar to module 256 of pixel 250, the consummation of acts 512-516 may result in the reduction of the charge stored on overflow module 402's overflow hold capacitor and storing of charge on the overflow hold capacitor of overflow module 406 to indicate that overflow module 402's overflow hold capacitor has reached saturation at least once. Similar results obtain if pixel well 404 implements a pixel well similar to well 262 of pixel 260 and overflow modules 402/406 similar to module 270 of pixel 260.

Process 500 may continue with a determination of whether to continue exposure of the array [act 518]. In one implementation of the invention, controller 108 may continue exposing pixel 400 depending upon a pre-determined exposure duration. If exposure of the array is to continue (i.e., the determination of act 518 is positive) then the determinations of acts 506 and 512 may be undertaken again. Thus, as FIG. 5 shows, as long as the determination of act 518 is positive then consecutive iterations of acts 506-516 may occur. In accordance with invention, each iteration of acts 508 and 510 may result in the storing of an additional charge on the overflow hold capacitor of overflow module 402, while each iteration of acts 514 and 516 may result in the storing of an additional charge on the overflow hold capacitor of overflow module 406 and the resetting or partial discharge of the overflow hold capacitor of overflow module 402.

If the determination of act 518 is negative, in other words if exposure of the array is not to continue, then process 500 may continue with the disabling of charge transfer [act 520]. One way to do this is if, in undertaking act 518, controller 108 determines that a pre-determined exposure duration has been met then controller 108 may, if module 404 implements a pixel well structure similar to pixel well 234 of pixel 200, release the charge transfer signal supplied to well module 404 thereby isolating well 404's hold capacitor from the well's photodiode so that no significant additional photo-induced charge is accumulated on the well's hold capacitor.

Process 500 may continue with the reading of the signal from the well's hold capacitor [act 522], from the overflow hold capacitor of the first overflow module [act 524] and from the overflow hold capacitor of the second overflow module [act 526]. In accordance with one implementation of the invention, acts 522-526 may be undertaken by having controller 108 supply a row select signal (RS) to row select transistors 408-412 thereby causing modules 402, 404, and 406 to supply their respective voltage levels to column address bus 414.

As those skilled in the art may recognize, the voltage level of well module 404's hold capacitor sampled in act 522 may be thought of as representing the LSBs (e.g., LSB_out) of the total voltage corresponding to the illumination experienced by pixel 400 during acts 504-520. Similarly, the voltage level of the overflow hold capacitor of the first overflow module 402 sampled in act 524 may be thought of as representing the LSBs of the MSBs (e.g., MSB_out(1)) of the total voltage corresponding to the illumination experienced by pixel 400 during acts 504-520. Likewise, the voltage level of the overflow hold capacitor of the second overflow module 406 sampled in act 526 may be thought of as representing the MSBs of the MSBs (e.g., MSB_out(2)) of the total voltage corresponding to the illumination experienced by pixel 400 during acts 504-520.

The acts shown in FIGS. 3 and 5 need not be implemented in the order shown; nor do all of the acts necessarily need to be performed. For example, removing charge from the first hold capacitor in act 310 may be undertaken before, during and/or after supplying charge to the second hold capacitor in act 308. Also, those acts that are not dependent on other acts may be performed in parallel with the other acts. For example, acts 316-318 and acts 522-526 may be undertaken in parallel. Moreover, some acts of processes 300 and 500 may be implemented in and/or undertaken using hardware and/or firmware and/or software. For example, the acts in process 300 of resetting the first hold capacitor and supplying the unit charge to the second hold capacitor (acts 310 and 308 respectively) may be implemented using hardware and/or firmware, while other acts such as determining whether to continue exposing the array (act 312) may be implemented in software. However, the invention is not limited in this regard and acts that may be implemented in hardware and/or firmware may, alternatively, be implemented in software. Clearly, many such combinations of software and/or hardware and/or firmware implementation of processes 300 and/or 500 may be contemplated consistent with the scope and spirit of the invention. Further, at least some of the acts in processes 300 and/or 500 may be implemented as instructions, or groups of instructions, implemented in a machine-readable medium.

In addition, the invention is not limited to a specific number of overflow modules. For example, pixel 200 of FIG. 2 has one overflow module 236 while pixel 400 of FIG. 4 has two overflow modules 402 and 406. To illustrate this point, FIG. 6 shows a pixel 600 incorporating a pixel well module 602 coupled to a cascade of N overflow modules 604(1)-604(N). Modules 602 and 604(1)-604(N) may be coupled to an N+1 bit column bus 606 by respective row select devices 608 and 610(1)-610(N). Bus 606 may then terminate in N+1 ADCs 612. Particular implementations of pixel 600 may, in accordance with the invention, be utilized in a process for sub-ranging pixel sample and hold similar to processes 300 and 500 with attendant modification to account for the number N of overflow modules employed in pixel 600.

The foregoing description of one or more implementations consistent with the principles of the invention provides illustration and description, but is not intended to be exhaustive or to limit the scope of the invention to the precise form disclosed. Modifications and variations are possible in light of the above teachings or may be acquired from practice of various implementations of the invention. Clearly, many implementations may be employed to provide a method, apparatus and/or system to implement sub-ranging pixel sample and hold consistent with the claimed invention.

No element, act, or instruction used in the description of the present application should be construed as critical or essential to the invention unless explicitly described as such. Also, as used herein, the article “a” is intended to include one or more items. In addition, some terms used to describe implementations of the invention, such as “data” and “value,” may be used interchangeably in some circumstances. For example, those skilled in the art will recognize that the terms “capacitor voltage” and “capacitor charge” may be used interchangeably without departing from the scope and spirit of the invention. Moreover, when terms such as “coupled” or “responsive” are used herein or in the claims that follow, these terms are meant to be interpreted broadly. For example, the phrase “coupled to” may refer to being communicatively, electrically and/or operatively coupled as appropriate for the context in which the phrase is used. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A method comprising:
accumulating charge on a first hold capacitance of an imaging pixel; and
accumulating charge on a second hold capacitance of the pixel in response to the first hold capacitance reaching a predetermined charge level.

2. The method of claim 1, wherein the predetermined charge level corresponds to overloading of charge on the first hold capacitance.

3. The method of claim 1, further comprising:
resetting the first hold capacitance in response to the first hold capacitance reaching the predetermined charge level.

4. The method of claim 1, further comprising:
partially removing charge from the first hold capacitance in response to the first hold capacitance reaching the predetermined charge level.

5. The method of claim 4, wherein partially removing charge from the first hold capacitance includes sourcing charge to a shunt capacitance.

6. The method of claim 5, wherein accumulating charge on the second hold capacitance of the pixel includes sourcing charge from the shunt capacitance to the second hold capacitance.

7. The method of claim 1, further comprising:
accumulating charge on a third hold capacitance of the pixel in response to the second hold capacitance reaching another predetermined charge level.

8. The method of claim 7, wherein the another predetermined charge level corresponds to overloading of charge on the second hold capacitance.

9. An apparatus comprising:
an imaging pixel of an imaging array, the imaging pixel including a hold capacitance and at least a first overflow hold capacitance capable of accumulating charge in response to the hold capacitance reaching a predetermined voltage level.

10. The apparatus of claim 9, wherein the imaging pixel further includes logic at least capable of comparing a voltage level of the hold capacitance to the predetermined voltage level and accumulating charge on the first overflow hold capacitance in response to the voltage level of the hold capacitance meeting or exceeding the predetermined voltage level.

11. The apparatus of claim 10, wherein the logic is further capable of sourcing charge away from the hold capacitance in response to the voltage level of the hold capacitance meeting or exceeding the predetermined voltage level.

12. The apparatus of claim 11, wherein sourcing charge away from the hold capacitance comprises at least partially discharging the hold capacitance.

13. The apparatus of claim 11, wherein sourcing charge away from the hold capacitance includes sourcing charge to a shunt capacitance.

14. The apparatus of claim 13, wherein the logic is further capable of moving charge from the shunt capacitance to the first overflow hold capacitance in response to a control signal.

15. The apparatus of claim 9, further comprising:
a second overflow hold capacitance,
wherein the logic is further capable of accumulating charge on the second overflow hold capacitance in response to the first overflow hold capacitance reaching or exceeding a predetermined voltage level.

16. The apparatus of claim 15, wherein the logic is further capable of at least partially discharging the first overflow hold capacitance in response to the first overflow hold capacitance reaching or exceeding the predetermined voltage level.

17. A system comprising:
an image sensor array, wherein an imaging pixel of the array includes hold capacitance and at least a first overflow capacitance; and
a controller to provide control signals to the image sensor array.

18. The system of claim 17, wherein the imaging pixel also includes logic at least capable of placing charge on the first overflow capacitance in response to the hold capacitance accumulating a predetermined amount of charge.

19. The system of claim 18, wherein the controller provides the logic with a reference voltage indicative of the predetermined amount of charge.

20. The system of claim 18, wherein the logic is further capable of sourcing at least some charge away from the hold capacitance in response to the hold capacitance accumulating the predetermined amount of charge.

21. The system of claim 17, further comprising:
second overflow capacitance,
wherein the logic is further capable of placing charge on the second overflow capacitance in response to the first overflow capacitance accumulating a predetermined amount of charge.

22. The system of claim 21, wherein the logic is further capable of sourcing at least some charge away from the first overflow capacitance in response to the first overflow capacitance accumulating the predetermined amount of charge.

23. The system of claim 17, further comprising:
an antenna coupled to the controller, the antenna to provide control data to the controller.

24. The system of claim 17, further comprising:
an image processor coupled to the imaging device, the image processor to receive image data from the imaging device.

25. The system of claim 24, wherein the image processor is one of a display processor, a multimedia processor or a printer processor.
